(19) United States
(12) Patent Application Publication
(10) Pub. No.: US 2011/0208484 A1
(43) Pub. Date: Aug. 25, 2011

(54) DESIGN APPARATUS FOR ELECTRONIC DEVICE, PROGRAM FOR DESIGNING ELECTRONIC DEVICE, AND METHOD OF DESIGNING ELECTRONIC DEVICE

(75) Inventors: Kouhei EZAKI, Kawasaki (JP); Kiyokazu Moriizumi, Kawasaki (JP); Takayuki Watanabe, Kawasaki (JP); Yuji Maeda, Kawasaki (JP)

(73) Assignee: FUJITSU LIMITED, Kawasaki-shi (JP)

(21) Appl. No.: 13/019,070

(22) Filed: Feb. 1, 2011

(30) Foreign Application Priority Data
Feb. 23, 2010 (JP) 2010-037176

(51) Int. Cl. G06F 17/50

(52) U.S. Cl. 703/1

(57) ABSTRACT

A design apparatus for an electronic device is provided. The apparatus includes: a selection unit that selects a first component which meets a characteristic condition, from a component database which includes a characteristic and a recommended level of each of components, the recommended level being variable; a first determination unit that acquires a recommended level of the first component from the component database, and determines the acquired recommended level; a creation unit that creates design data of the electronic device including the first component; and a second determination unit that acquires, after the creation, a recommended level of the first component from the component database, and determines the acquired recommended level after the creation.

### CROSS-REFERENCE TO RELATED APPLICATIONS

This application is based upon and claims the benefit of priority of the prior Japanese Patent Application No. 2010-037176, filed on Feb. 23, 2010, the entire contents of which are incorporated herein by reference.

### FIELD

The embodiments discussed herein are related to a technique for designing an electronic device.

### BACKGROUND

There is known a technique for selecting a component (part) used for an electronic device from among components registered in a component database when one designs the electronic device (Patent Documents 1, 2, 3 and 4 that will be listed later).

When a designer selects a component from a component database, plural candidates of components which meet a required function, exist in many cases. In this case, one component is selected from the plural candidates according to information, such as a function or confidence of component, which is disclosed by a component manufacturer, and criteria for determination by respective designers or policies of respective sections. Then, due to lack of unification of the criteria for determination by respective in-house designers or policies of respective sections in a company, components used in the company are not uniformed. In such a case where components are not uniformed (standardized) in one company, a number of processes for manufacturing an electronic device is increased because of the complicated procedure for arrangement of components or for stock control, thereby increasing the electronic device cost.
[Patent Document 1] Japanese Laid-open Patent Publication No. 11-238069
[Patent Document 2] Japanese Laid-open Patent Publication No. 4-277864
[Patent Document 3] Japanese Laid-open Patent Publication No. 2001-265838
[Patent Document 4] Japanese Laid-open Patent Publication No. 2005-56003

By registering an evaluation of component which is based on unified evaluation criteria, into the component database, component selection may be conducted according to the evaluation. However, when the evaluation of component varies during designing, it may happen that a component which has been included in design data falls outside highly evaluated components.

### SUMMARY

According to an aspect of the invention, there is provided a design apparatus for an electronic device, the apparatus including: a selection unit that selects a first component which meets a characteristic condition, from a component database which includes a characteristic and a recommended level of each of components, the recommended level being variable; a first determination unit that acquires a recommended level of the first component from the component database, and determines the acquired recommended level; a creation unit that creates design data of the electronic device including the first component; and a second determination unit that acquires, after the creation, a recommended level of the first component from the component database, and determines the acquired recommended level after the creation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of an electronic device design system;

FIG. 2 is a block diagram illustrating the configuration of a computer system;

FIG. 3 is a diagram illustrating a component DB;

FIG. 4 is a diagram illustrating recommended ranks;

FIG. 5 is a diagram illustrating compatibility ranks;

FIG. 6 is a diagram illustrating category information;

FIG. 7 is a sequence diagram illustrating an example of operations of the electronic device design system;

FIG. 8 is a flowchart illustrating the component DB management processing;

FIG. 9 is a flowchart illustrating the design data creation processing;

FIG. 10 is a flowchart illustrating the component selection processing;

FIG. 11 is a diagram illustrating a first example of a search condition input screen;

FIG. 12 is a diagram illustrating a second example of the search condition input screen;

FIG. 13 is a diagram illustrating an extracted component screen;

FIG. 14 is a flowchart illustrating the component determination processing;

FIG. 15 is a diagram illustrating a substitution component screen;

FIG. 16 is a diagram illustrating a usage permission request screen;

FIG. 17 is a diagram illustrating usage permission information; and

FIG. 18 is a diagram illustrating an example of a computer system to which the present invention may be applied.

### DESCRIPTION OF EMBODIMENT

An embodiment of the present invention will be described below with reference to the accompanying drawings.

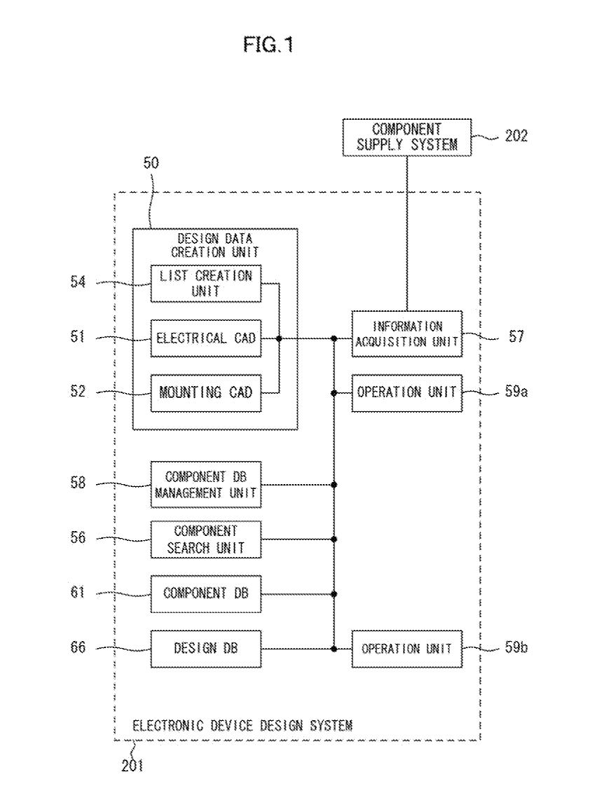

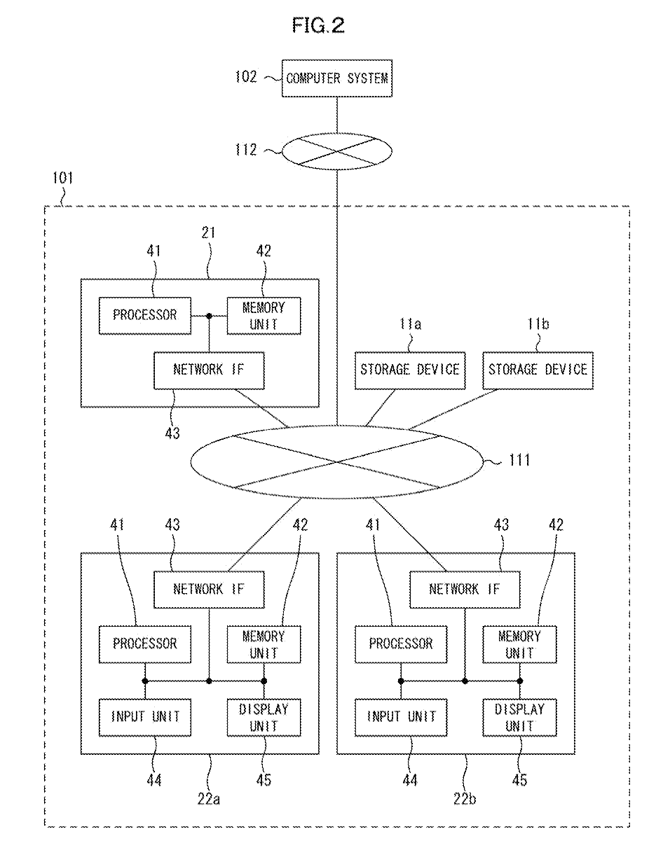

FIG. 1 is a functional diagram illustrating a configuration of an electronic device design system, and FIG. 2 is a bock diagram illustrating a configuration of a computer system. The electronic device design system 201 illustrated in FIG. 1 is an example of the application of a design apparatus of the present invention, and is a system for designing an electronic device. The electronic device design system 201 includes a design data creation unit 50, a component search unit 56, an information acquisition unit 57, a component DB management unit 58, operation units 59a and 59b, a component DB (database) 61 and a design DB 66. The design data creation unit 50 includes an electrical CAD 51, a mounting CAD 52 and a list creation unit 54. The operation unit 59a controls the design data creation unit 50 based on the instructions from an electronic device designer. The operation unit 59b controls the information acquisition unit 57 and the component DB management unit 58 based on the instructions from an administrator of the component DB 61.

The electronic device design system 201 illustrated in FIG. 1 may be implemented by a computer system 101 illustrated in FIG. 2. The computer system 101 includes storage devices 11a and 11b and computers 21, 22a, and 22b. The storage devices 11a, 11b and the computers 21, 22a, and 22b are connected from one another via an internal network 111. The internal network 111 is connected to a computer system 102 via an external network 112. The computer system 101 is placed in an electronic device manufacturer for designing and manufacturing an electronic device, and the computer system 102 is placed in a component manufacturer for providing with components.

The component supply system 202 may be implemented by the computer system 102. The component supply system 202 sends component supply information which indicates characteristics and statuses of components that may be used to the electronic device, to the information acquisition unit 57 by e-mail or the like.

Each of the computers 21, 22a, and 22b includes a processor 41 such as a CPU (Central Processing Unit), a memory unit 42 such as a semiconductor memory or a HDD (Hard Disk Drive), and a network interface (interface) 43. Furthermore, each of the computers 21, 22a, and 22b includes an input unit 44 and a display unit 45.

The design data creation unit 50, the component search unit 56, and the component DB management unit 58 may be implemented by the computer 21, for example. In the computer 21, the memory unit 42 stores a design program allowing the processor 41 to execute functions of the design data creation unit 50 and the component search unit 56. The component DB 61 may be stored in the storage device 11a. The design DB 66 may be stored in the storage device 11b.

The operation unit 59a may be implemented by a computer 22a. The computer 22a communicates with the computer 21 so as to utilize the design data creation unit 50 and the component search unit 56. The computer 22a transmits an instruction input on the input unit 44 by the designer to the computer 21, and displays screen information transmitted from the computer 21 on the display unit 45.

The operation unit 59b and the information acquisition unit 57 may be implemented by the computer 22b. The computer 22b communicates with the computer 21 so as to utilize the component DB management unit 58. The computer 22b transmits an instruction input on the input unit 44 by the administrator to the computer 21, and displays screen information transmitted from the computer 21 on the display unit 45.

Note that, the design data creation unit 50, the component search unit 56 and the component DB management unit 58 may be respectively mounted on different devices. Otherwise, the design data creation unit 50, the component search unit 56, the information acquisition unit 57, the component DB management unit 58 and the operation units 59 and 59b may be mounted on the same device.

Furthermore, a condition determination unit may include the component search unit 56. A selection unit may include the component search unit 56. An assignment unit may include the design data creation unit 50. A first determination unit may include the component search unit 56. A creation unit may include the design data creation unit 50. A second determination unit may include the component search unit 56.

The component DB 61 will be described below.

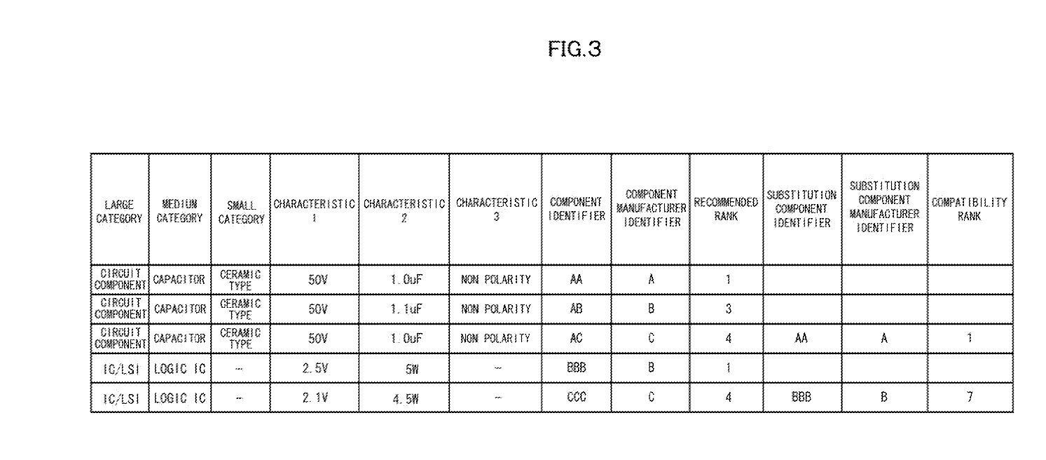

FIG. 3 is a diagram illustrating the component DB. The component DB 61 registers entries of component information for each of the components. Furthermore, the component DB 61 includes fields for each component. The fields respectively represent a large category, a medium category, a small category, characteristics 1, 2, 3, a component identifier, a component manufacturer identifier, a recommended rank, a substitution component identifier, a substitution component manufacturer identifier and a compatibility rank. A content of the large category represents a circuit component or a mounted component, for example. When the content of the large category represents a circuit component, a content of the medium category represents a capacitor or a resistance, for example. When the content of the medium category represents a capacitor, a content of the small category represents a ceramic type or an electrolysis type, for example. According to the contents in the large category, the medium category and the small category, a component type is specified. A content of the component identifier is a value such as a component name or a model number, for identifying a corresponding component. A content of the component manufacturer identifier is a value such as a name of component manufacturer or a number which has bee assigned to a component manufacturer, for identifying a supplier of a corresponding component. A content of the recommended rank is defined in order to standardize components used by an electronic device manufacturer. The higher the recommended rank of a component is, the higher the priority of usage of the component.

In place of the recommended rank of component, priority or a priority level of the component can be used. A recommendation level may include the priority rank, the priority order and the priority level.

The substitution component identifier, the substitution component manufacturer identifier and the compatibility rank are substitution component information relating to a substitution component. The substitution component identifier is a component identifier indicating a component which may be replaced with a pertinent component. The substitution component manufacturer identifier is a component manufacturer identifier which is indicated by an entry in the component identifier specified by the substitution component identifier. The compatibility rank indicates compatibility between the pertinent component and a substitution component for the pertinent component.

Contents of the component DB 61 may be changed by the component DB management unit 58 at anytime.

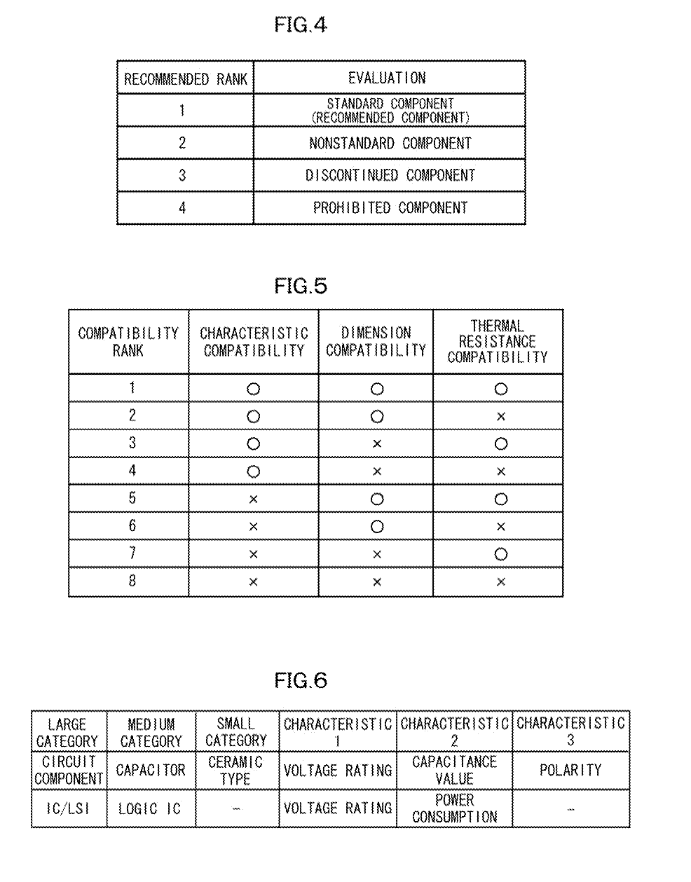

FIG. 4 is a diagram illustrating the recommended ranks. In the illustrated example, a recommended rank is represented in four-level values. When a value of the recommended rank is “4”, a component of the recommended rank is a prohibited component which is prohibited from use in the electronic device manufacturer. When a value of the recommended rank is “3”, a component of the recommended rank is discontinued by a component manufacturer. When a value of the recommended rank is “2”, a component of the recommended rank may be supplied by a component manufacturer, but is a nonstandard component which is not recommended in the electronic device manufacturer. When a value of the recommended rank is “1”, a component of the recommended rank is a standard component which is recommended in the electronic device manufacturer.

FIG. 5 is a diagram illustrating the compatibility ranks. In the illustrated example, a compatibility rank is represented in eight-level values for indicating characteristic compatibility specifying compatibility between a characteristic of a pertinent component and that of a substitution component for the pertinent component, dimension compatibility specifying compatibility between a dimension of the pertinent component and that of the substitution component, and thermal resistance compatibility specifying that a thermal resistance of the substitution component is upwardly compatible with that of the pertinent component. When a value of the compatibility rank is “1”, the substitution component completely meets the characteristic compatibility, the dimension compatibility and the thermal resistance compatibility so that the substitution component is fully compatible with the pertinent component. When a value of the compatibility rank is “2”, the substitution component meets the characteristic compatibility and the dimension compatibility. When a value of the compatibility rank is “3”, the substitution component meets the characteristic compatibility and the thermal resistance compatibility. When a value of the compatibility rank is “4”, the substitution component meets the characteristic compatibility. When a value of the compatibility rank is “5”, the substitution component meets the dimension compatibility and the thermal resistance compatibility. When a value of the compatibility rank is “6”, the substitution component meets the dimension compatibility. When a value of the compatibility rank is “7”, the substitution component meets the thermal resistance compatibility. When a value of the compatibility rank is “8”, the substitution component does not meet any of the characteristic compatibility, the dimension compatibility and the thermal resistance compatibility. A substitution component whose compatibility rank is one of “1” to “7” is determined to be compatible with a pertinent component, and a substitution component whose compatibility rank is “8” is determined to be incompatible with the pertinent component.

When a component is adopted, i.e. when a component is registered into the component DB 61, the component is evaluated. A technical evaluation, a market evaluation and cost/performance of the component contribute an integrated evaluation of the component. When the component is registered into the component DB 61, the higher the component is integrally evaluated, the higher a recommended rank is set. The technical evaluation is determined based on whether or not a technology used in the component will meet requirements of a future electronic device, as a criterion. For example, when a component type is a CPU, a multi-core type where a plural CPU cores are integrated into a one part, improves the technical evaluation, and a power saving feature of the component further improves the technical evaluation. The market evaluation is determined based on which is an optimal technique required by a common client, as a criterion. For example, even though the technical evaluation of a component is high, the component may not be required in a market. The cost/performance is determined by comparing components having the same function and the same performance. When the integrated evaluation is not high, even if the component is adopted, the component may be registered into the component DB 61 as the nonstandard component (the recommended rank is set to “2”). When a component is adopted, the substitution component information is not registered into the component DB 61, basically.

After adoption of component, an evaluation of the component is reviewed every time a predetermined period lapses, and a review of the evaluation is accompanied with a review of the recommended rank of the component in the component DB 61. The predetermined period may be six months, for example. When the recommended rank of the component is changed to indicate an evaluation which is lower than or equal to the nonstandard component (the recommended rank is set to a value lower than or equal to “2”) as a result of reviewing the evaluation of the component, a component which may be a substitution component of the component at the time is extracted from the component DB 61, and the extracted substitution component is registered into the substitution component information of the corresponding component. Every time an evaluation is reviewed, substitution component information is reviewed, and a substitution component having a highest recommended rank at the time is set as the substitution component information.

When the component supply information which is transmitted from the component supply system 202 indicates that production of a component is discontinued, a recommended rank of the corresponding component is changed to indicate discontinued component (the recommended rank is set to “3”). In this case, substitution component information of the component is reviewed and a substitution component having a highest recommended rank at the time is set as the substitution component information.

Furthermore, regarding a component whose substitution component information has been set to the nonstandard component (the recommended rank is set to “2”), when a substitution component having a recommended rank which is higher than that of a substitution component indicated by the substitution component information, becomes usable (employable), the former substitution component is set as the substitution component information.

The component DB 61 also includes category information. FIG. 6 is a diagram illustrating the category information. The category information includes a large category, a medium category and a small category for each of component types, and items of characteristics 1, 2, 3 respectively corresponding to the categories. When a content of the medium category indicates a capacitor, a value of the characteristic 1 is a value [V] of the voltage rating, for example. When a content of the medium category indicates a capacitor, a value of the characteristic 2 is a capacitance value [F], for example. When a content of the medium category indicates a capacitor, a value of the characteristic 3 indicates presence of absence of the polarity, for example.

The design DB 66 stores design data. The design data includes an all components list listing all components which are used in a design target electronic device, a circuit diagram indicating a result of circuit design on designing for the design target electronic device, and a mounting diagram indicating a result of mounting design on designing for the design target electronic device, for example.

The operations of the electronic device design system 201 will be described below.

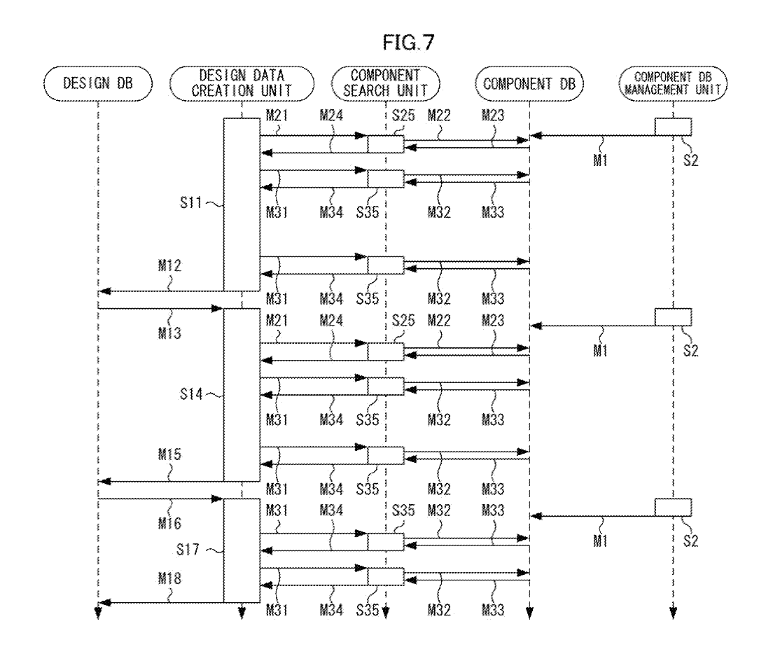

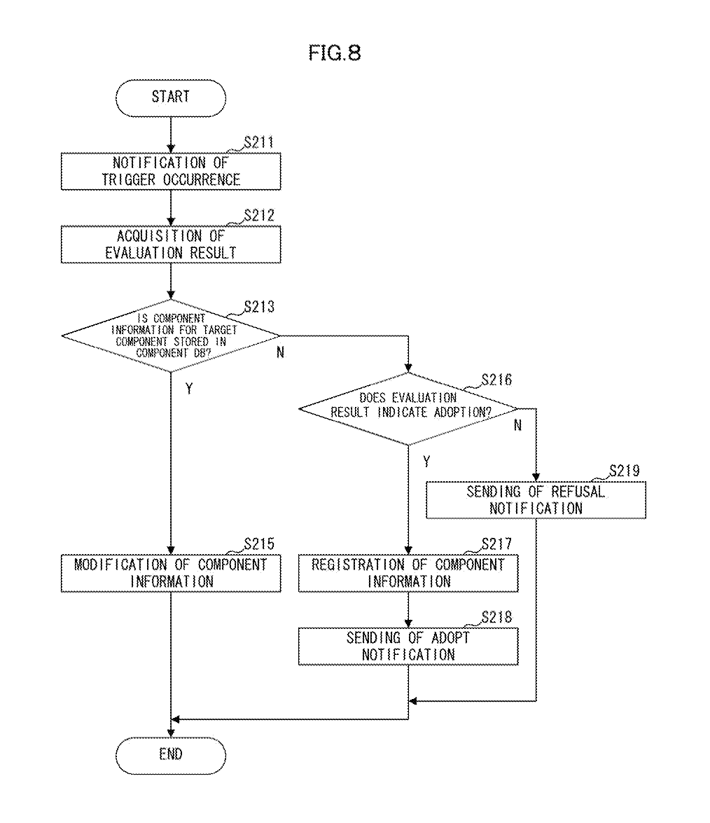

FIG. 7 is a sequence diagram illustrating an example of operations of the electronic device design system. The sequence diagram illustrates, starting from the left, operations of the design DB 66, the design data creation unit 50, the component search unit 56, the component DB 61 and the component DB management unit 58.

The component DB management unit 58 conducts the component DB management processing based on an evaluation of a component (S2, modify the component database at the time a predetermined trigger occurs) every time a trigger of the component DB management processing (the predetermined trigger) occurs. The component DB management processing modifies the component DB 61 (M1).

On the other hand, the list creation unit 54 of the design data creation unit 50 initially selects a component which is to be used in the design target electronic device, from the component DB 61 so as to conduct the list creation processing for creating the all components list (S11) and to register the created all components list into the design DB 66 (M12). Next, the electrical CAD 51 acquires the all components list from the design DB 66 (M13), conducts the circuit diagram creation processing for creating the circuit diagram based on the all components list (S14), and registers the created circuit diagram into the design DB 66 (M15). Next, the mounting CAD 52 acquires the all components list and the circuit diagram from the design DB 66 (M16), conducts the mounting diagram creation processing for creating the mounting diagram based on the all components list and the circuit diagram (S17), and registers the created mounting diagram to the design DB 66 (M18). From the foregoing processing, each of design data is created and manufacturing of the design target electronic device is started based on the design data.

On the above list creation processing (S11), the above circuit diagram creation processing (S14) or the above mounting diagram creation processing (S17), when a new component is added to the design data, the design data creation unit 50 instructs the component search unit 56 to conduct the component selection processing for selecting a component (M21), and then the component search unit 56 conducts the component selection processing. On the component selection processing, the component search unit 56 searches the component DB 61 (M22), acquires the component information from the component DB 61 (M23), and selects a component so as to send the selection result to design data creation unit 50 (M24). Furthermore, after the component selection processing or when the design data is checked, the design data creation unit 50 instructs the component search unit 56 to conduct the component determination processing (M31), and then the component search unit 56 conducts the component determination processing (S35). On the component determination processing, the component search unit 56 searches the component DB 61 (M32), acquires the component information from the component DB 61 (M33), and determines the component so as to send the determination result to the design data creation unit 50 (M34).

As described above, the component DB management processing (S2) is conducted at an occurrence of the predetermined trigger, the list creation processing (S11), the circuit design processing (S14) and the mounting design processing (S17) are conducted according to the design flow. Consequently, the timing of the component DB management processing is asynchronous to the timing of the list creation processing, the circuit design processing and the mounting design processing. Hence, during the list creation processing, the circuit design processing or the mounting design processing, the component DB 61 may be modified. Specifically, after a component is determined according to one of the list creation processing, the circuit design processing and the mounting design processing, a recommended level of the component may be changed before creation of the design data is completed.

The component DB management processing will be described below.

A trigger of the component DB management processing may be the case where a predetermined period elapse after the component DB management processing for a component, or the case where the information acquisition unit 57 receives information relating to the component information. The information relating to the component information may be, for example, an adoption request, component supply information, technical trend information, market trend information, a catalog of components, or information indicating reliability of component. The adoption request is transmitted from the component search unit 56 to the information acquisition unit 57, for requesting adoption of a corresponding component. The component supply information is transmitted from the component supply system 202 to the information acquisition unit 57, indicating a supply situation of the corresponding component. The technical trend information indicates a technical trend of component. The market trend information indicates a market trend of component. Furthermore, the information relating to the component information includes a component type or a characteristic of the corresponding component. The component supply information may be transmitted from the component supply system 202 to the information acquisition unit 57, or be transmitted from the component supply system 202 to the information acquisition unit 57 in response to a request from the information acquisition unit 57 to the component supply system 202.

FIG. 8 is a flowchart illustrating the component DB management processing. The component DB management processing in the case where a trigger of the component DB management processing is reception of the adoption request will be described. When the trigger of the component DB management processing occurs, the component DB management unit 58 notifies the occurrence of trigger to a administer (S211). The administer conducts the above integrated evaluation for a corresponding component and inputs a revaluation result into the information acquisition unit 57. The component DB management unit 58 acquires the integrated evaluation result from the information acquisition unit 57 (S212). Next, the component DB management unit 58 determines whether or not component information of the component has already stored in the component DB 61 (S213).

When the component information of the component has already stored in the component DB 61 (S213, Y), the component DB management unit 58 modifies the component information of the component stored in the component DB 61 based on the acquired evaluation result (S215) so that the flowchart ends.

When the component information of the component is not stored in the component DB 61 (S213, N), the component DB management unit 58 determines whether or not the acquired evaluation result indicates adoption of the component (S216). When it is determined that the acquired evaluation result indicates the adoption of the component (S216, Y), the component DB management unit 58 creates component information of the component based on the evaluation result, registers it into the component DB 61 (S217), and transmits an adopt notification of the adoption request to the component search unit 56 (S218) so that the flowchart ends. When it is determined that the evaluation result indicates a refusal for adoption (S216, N), the component DB management unit 58 transmits a refusal notification of the adoption request to the component search unit 56 (S219) so that the flowchart ends.

Note that, when the information acquisition unit 57 receives the information relating to the component information, the information acquisition unit 57 may conduct the integrated evaluation based on the received information.

The design data creation processing by the design data creation unit 50 will be described.

The design data creation processing is one of the list creation processing by the list creation unit 54, the circuit design processing by the electrical CAD 51, and the mounting design processing by the mounting CAD 52, and design data is created. Design data in the design data creation processing is a list of all components, design data in the circuit design processing is a circuit diagram, and design data in the mounting design processing is a mounting diagram. The creation of design data includes, such as an addition of component, a deletion of component, a movement of component and wiring between components.

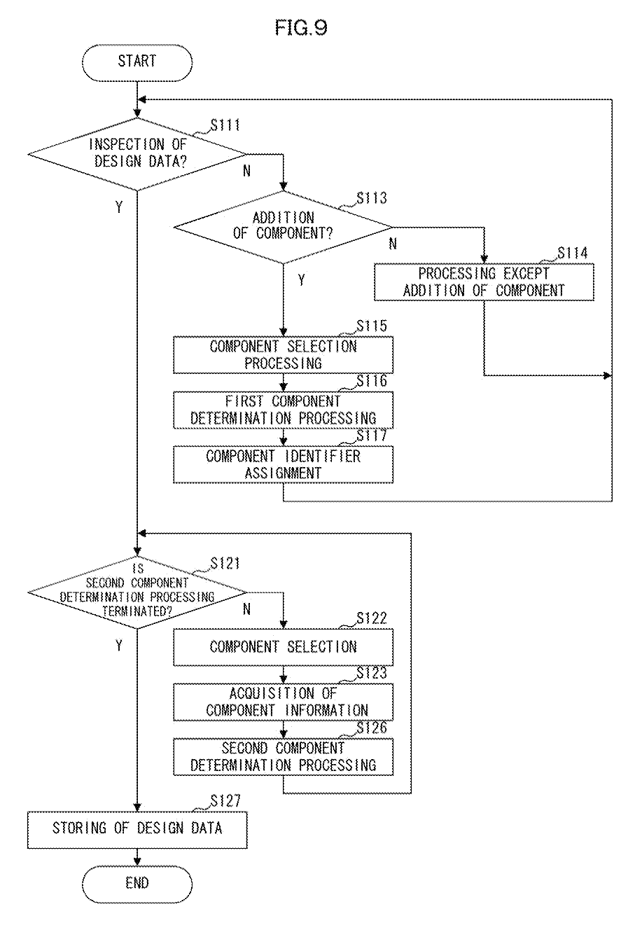

FIG. 9 is a flowchart illustrating the design data creation processing. First, the design data creation unit 50 determines whether or not an input instruction indicates an inspection of design data (S111).

When the instruction does not indicate the inspection of design data (S111, N), the design data creation unit 50 determines whether or not a subsequently-input instruction indicates the addition of component (S113). When the instruction does not indicate the addition of component (S113, N), the design data creation unit 50 conducts the processing except the addition of component (S114), thereby returning a process of the flowchart to S111. The processing except the addition of component includes the deletion of component, the movement of component or the wiring between components, for example. When the instruction indicates the addition of component (S113, Y), the component search unit 56 conducts the component selection processing for selecting the component (S115), conducts first component determination processing for determining the selected component by the component selection processing (S116, conduct determination by acquiring a recommended level of a first component based on an identifier of the first component), assigns a component identifier of the additional component to an component identifier determined by the first component determination processing (S117), thereby returning a process of he flowchart to S111.

When the instruction indicates the inspection of design data (S111, Y), the design data creation unit 50 determines whether or not all of second component determination processing are completed (S121). When all of the second component determination processing are not completed (S121, N), the design data creation unit 50 selects a component from among all components in the design data (S122) and acquires component information of the selected component from the component DB 61 (S123). Next, the component search unit 56 conducts the second component determination processing for the selected component (S126, after the creation, conduct determination by acquiring the recommended level of the first component based on the identifier of the first component), thereby returning a process of flowchart to S121. When all of the second component determination processing are completed (S121, Y), the design data creation unit 50 stores the design data into the design DB 66 (S127) so that the flowchart ends.

The above component selection processing (S115) will be described below.

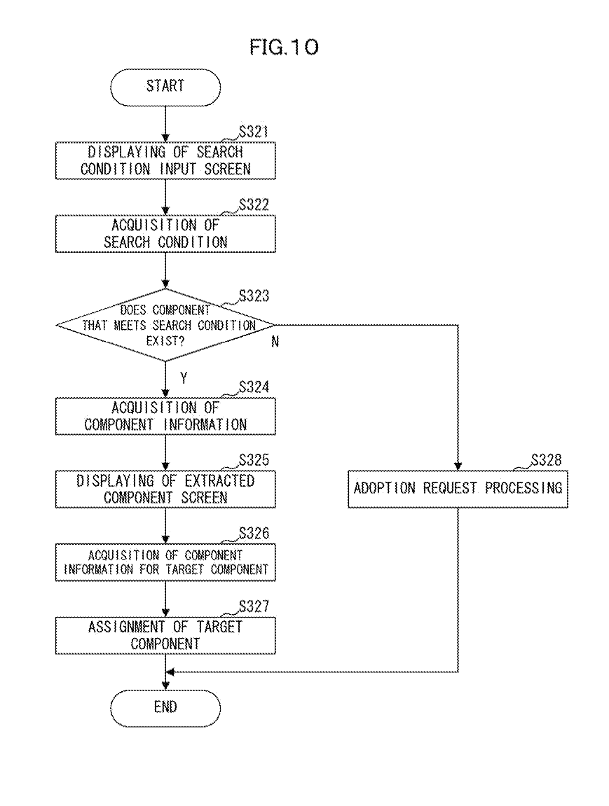

FIG. 10 is a flowchart illustrating the component selection processing. The component search unit 56 which is instructed by the design data creation unit 50 to conduct the component selection processing, displays a search condition input screen for determining search conditions of component (S321). The search conditions include a component type indicating a type of component and a characteristic condition indicating a characteristic of component.

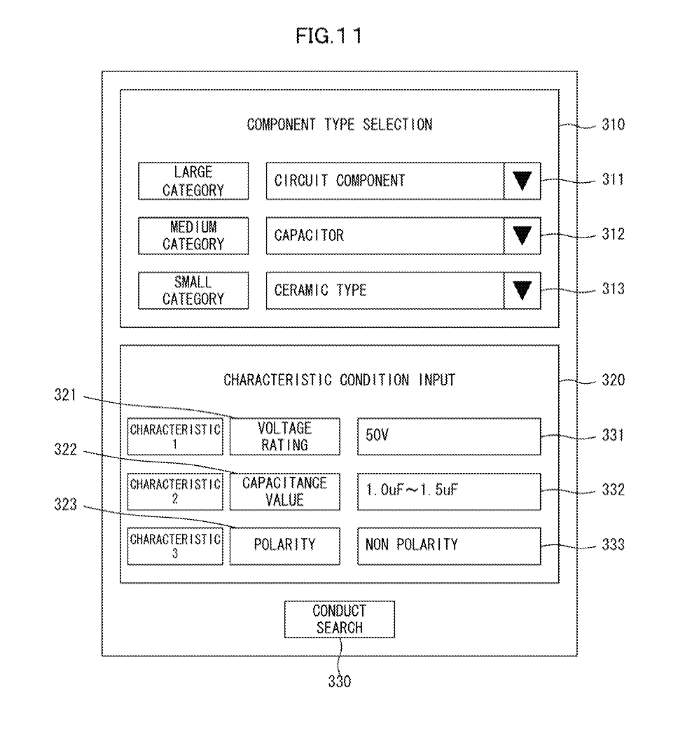

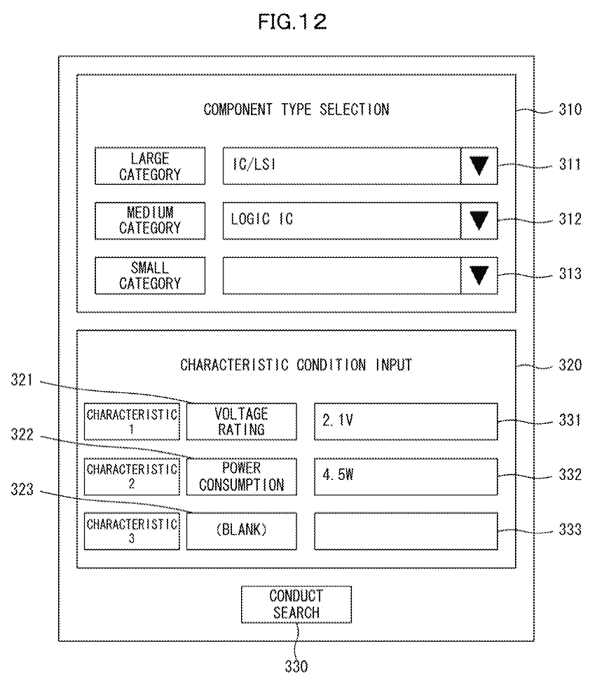

FIG. 11 is a diagram illustrating a first example of the search condition input screen. FIG. 12 is a diagram illustrating a second example of the search condition input screen. The search condition input screen includes a component type selecting section 310 for selecting a component type and a characteristic condition inputting section 320 for inputting a characteristic condition. The component type selecting section 310 includes a large category selecting section 311 for selecting a large category, a medium category selecting section 312 for selecting a medium category, and a small category selecting section 313 for selecting a small category. The characteristic condition inputting section 320 includes an item name displaying section 321 for displaying an item name of a characteristic 1, a value inputting section 331 for inputting an value of the characteristic 1, an item name displaying section 322 for displaying an item name of a characteristic 2, a value inputting section 332 for inputting a value of the characteristic 2, an item name displaying section 323 for displaying an item name of a characteristic 3, and an value inputting section 333 for inputting a value of the characteristic 3. First, the component search unit 56 acquires category information from the component DB 61 and displays the category information. The designer selects contends of a large category, a medium category and a small category for a desired component type from the displayed category information and respectively inputs them in the large category selecting section 311, the medium category selecting section 312 and the small category selecting section 313. Consequently, the component type of the search condition is determined. Next, the component search unit 56 respectively displays item names of the characteristics 1, 2, 3 corresponding to the component type on the item name displaying sections 321, 322, 333 based on the component type selected in the component type selecting section 310 and the category information in the component DB 61.

Note that, the component search unit 56 may determine the component type in the order of the large category, the medium category, the small category, based on the category information. In this case, the component search unit 56 acquires the category information in the component DB 61, displays an option for the value of the large category on the large category selecting section 311, when the value of the large category is selected according to an input instruction, displays an option for the value of the medium category which belongs to the selected large category on the medium category selecting section 312, and, when the value of the medium category is selected according to an input instruction, displays an option for the value of the small category which belongs to the selected medium category on the small category selecting section 313, so that a value of the small category is selected according to an input instruction.

As illustrated in the first example of the search condition input screen, a circuit component, a capacitor and a ceramic type are respectively selected in the large category selecting section 311, the medium category selecting section 312, and the small category selecting section 313 of the component type selecting section 310. Based on the selected component type and the category information, a voltage rating, a capacitance value and a polarity are respectively displayed in the item name displaying section 321 for the characteristic 1, the item name displaying section 322 for the characteristic 2, and the item name displaying section 323 for the characteristic 3 of the characteristic condition inputting section 320. By instructions from the designer, values for the characteristics 1, 2, 3 are respectively input in the value inputting sections 331, 332, 333.

As illustrated in the second example of the search condition input screen, an Integrated Circuit/Large Scale Integration (IC/LSI) and a logic IC are respectively selected in the large category selecting section 311 and the medium category selecting section 312 of the component type selecting section 310, and a small category is not selected. Based on the selected component type and the category information, a voltage rating, a power consumption and a blank are respectively displayed in the item name displaying section 321 for the characteristic 1, the item name displaying section 322 for the characteristic 2, and the item name displaying section 323 for the characteristic 3 of the characteristic condition inputting section 320. By instructions from the designer, values for the characteristics 1, 2, 3 are respectively input in the value inputting sections 331, 332, 333.

The component search unit 56 acquires a search condition which is input on the search condition input screen (S322, determines a characteristic condition). The component search unit 56 searches the component DB 61 for a component which meets the search condition, and determines whether or not the component meeting the search condition is registered in the component DB 61 (S323).

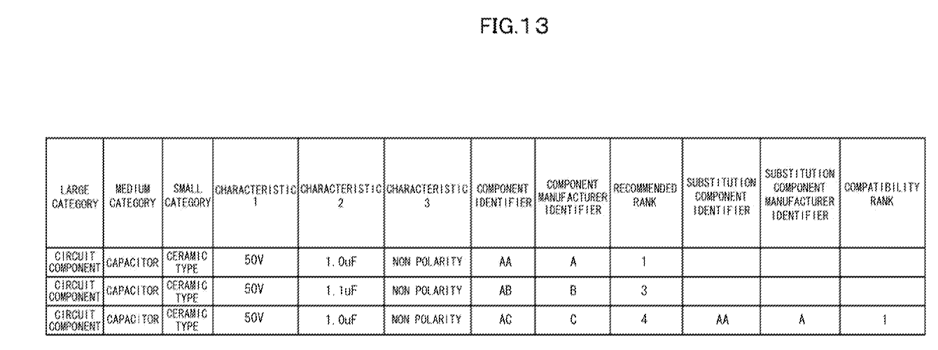

When the component which meets the search condition is registered in the component DB 61 (S323, Y), the component search unit 56 acquires component information of the component meeting the search condition from the component DB 61 (S324), and displays an extracted component screen indicating the extracted component information (S325). FIG. 13 is a diagram illustrating the extracted component screen. On the extracted component screen, the component information which is extracted from the above example of the component DB 61 based on the search condition indicated by the first example of the above search condition input screen, is indicated. On the extracted component screen, component information of three components is extracted from the component information indicated in the example of the above component DB 61. The designer inputs an instruction to select one of the components on the extracted component screen of the component search unit 56. The component search unit 56 acquires component information of a target component which is selected according to the input instruction (S326, selects a component which meets the characteristic condition), and assigns the component identifier and the characteristic of the target component to a component to be added to the design data (S327, assigns an identifier of the selected component to an identifier of a first component), so that the flowchart ends. Note that, the component search unit 56 may select a component having a highest recommended rank among the extracted component information.

When a component which meets the search condition is not registered in the component DB 61 (S323, N), the component search unit 56 conducts the adoption request processing for requesting adoption of a new component which meets the search condition (S328) so that the flowchart ends.

In the adoption request processing (S328), the designer investigates the new component which meets the search condition. The component search unit 56 transmits the adoption request for requesting adoption of the investigated component to the information acquisition unit 57. The component DB management unit 58 conducts the component DB management processing in response to the reception of the adoption request, and transmits a notification of an adoption or a refusal for adoption to the component search unit 56. When the component search unit 56 receives the notification, the component search unit 56 conducts the component selection processing for using the component, again.

According to the component selection processing, a component which meets the search condition may be selected from the component DB 61 as a target component.

The above component determination processing (S116, S126) will be described below.

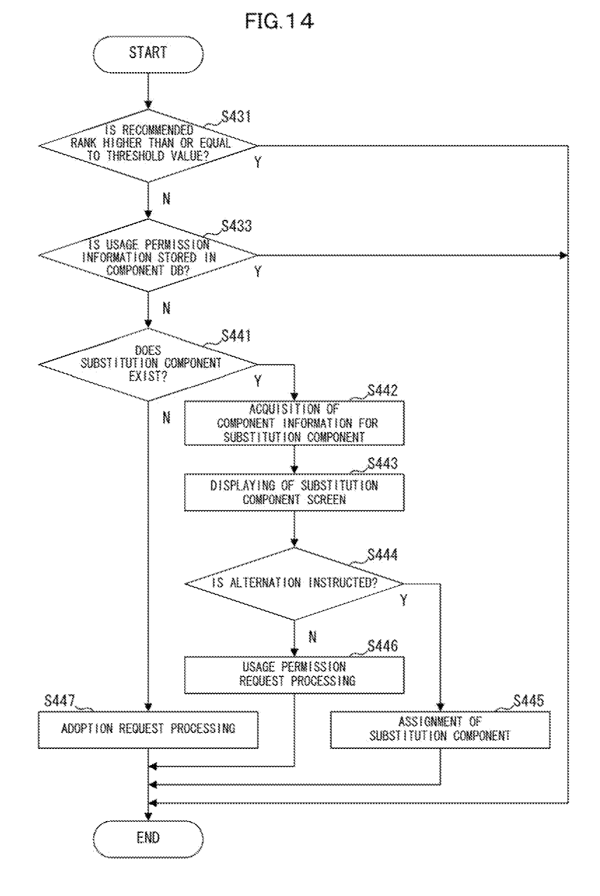

FIG. 14 is a flowchart illustrating the component determination processing. The component search unit 56 refers to component information of the target component and determines whether or not a recommended rank of the target component is higher than or equal to a threshold value of recommended rank (S431).

When the recommended rank of the target component is higher than or equal to the threshold value of recommended rank (S431, Y), the component search unit 56 ends the flowchart.

When the recommended rank of the target component is lower than the threshold value of recommended rank (S431, N), the component search unit 56 searches the component DB 61 for a component identifier of the target component, and determines whether or not usage permission information of the target component is stored in component DB 61 (S433).

When the usage permission information of the target component is stored in component DB 61 (S433, Y), the component search unit 56 ends the flowchart.

When the usage permission information of the target component is not stored in component DB 61 (S433, N), the component search unit 56 refers to a compatibility rank of the component information of the target component, and determines whether or not the substitution component which is compatible with the target component exist (S411).

When the substitution component exists (S441, Y), the component search unit 56 refers to a substitution component identifier of the component information of the target component, searches the component DB 61 for a substitution component having the substitution component identifier, acquires component information of the substitution component from the component DB 61 (S442), and causes the display unit 45 to display a substitution component screen indicating the substitution component (S443). FIG. 15 is a diagram illustrating a substitution component screen. The substitution component screen includes a component identifier displaying section 341 for displaying a component identifier of the substitution component, a component manufacturer identifier displaying section 342 for displaying a component manufacturer identifier of the substitution component, and a recommended rank displaying section 343 for displaying a recommended rank of the substitution component, from among the component information of the substitution component. The substitution component screen also includes a substitution instructing section 351 for inputting a substitution instruction indicating substitution of the substitution component for the target component, and a substitution refusal instructing section 352 for inputting a substitution refusal instruction indicating a refusal of the substitution. The designer inputs an instruction of the substitution instructing section 351 or the substitution refusal instructing section 352 based on the information displayed on the substitution component screen. The component search unit 56 may display an alert which indicates that the recommended rank of the target component is lower than the threshold value of recommended rank. The component search unit 56 acquires the input instruction and determines whether or not the instruction is the substitution instruction (S444).

When the instruction is the substitution instruction (S444, Y), the component search unit 56 assigns the component identifier and the characteristic of the substitution component to the component identifier and the characteristic of the target component so that the flowchart ends. When the instruction is not the substitution instruction, e.g. the substitution refusal instruction (S444, N), the component search unit 56 conducts the usage permission request processing (S446) so that the flowchart ends. When the recommended rank of the substitution component is higher than or equal to the threshold value of recommended rank, the component search unit 56 may use the component identifier and the characteristic of the substitution component for the assignment in place of the component identifier and the characteristic of the target component.

When the substitution component does not exist (S441, N), the component search unit 56 conducts the adoption request processing in the same manner as S328 (S447) so that the flowchart ends.

According to the component determination processing, it may be determined whether or not the recommended rank of a component of the design data at the time is higher than or equal to the threshold value of recommended rank. When the recommended rank of the component of the design data is lower than the threshold value of recommended rank, the component may be replaced with the substitution component. Note that, the component search unit 56 may change the threshold value of recommended rank to a value instructed by the designer. A recommended level threshold value may include the recommended rank.

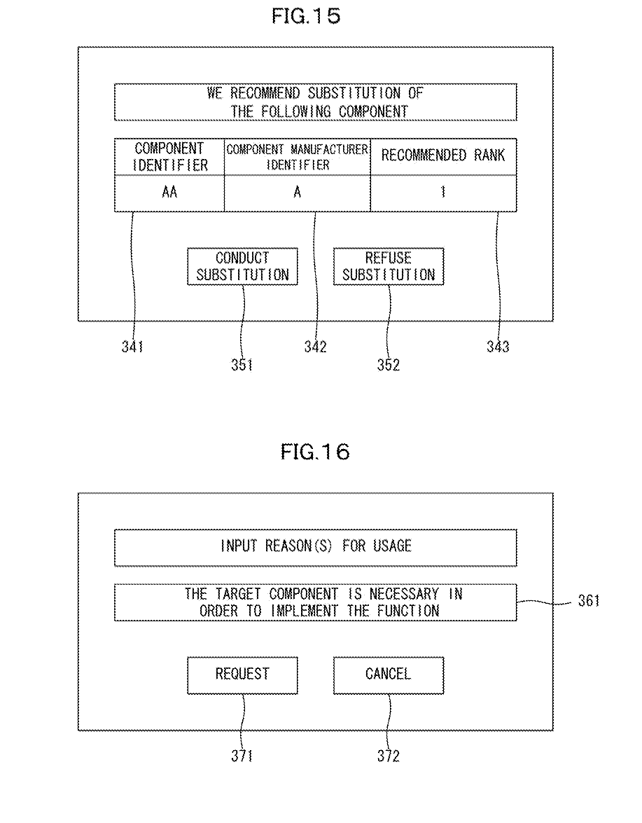

The above usage permission request (S446) is conducted when it is necessary for the designer to use the target component even if the recommended rank of the target component is lower than the threshold value of recommended rank. In the usage permission request, the component search unit 56 displays a usage permission request screen for requesting usage permission of the target component. FIG. 16 is a diagram illustrating the usage permission request screen. The usage permission request screen includes a usage reason inputting section 361 where the designer inputs a usage reason of the target component, a request instructing section 371 for transmitting a usage permission request, and a cancel instructing section 372 for cancelling a usage permission request. When the designer wants to transmit the usage permission request, the designer inputs the usage reason(s) into the usage reason inputting section 361, and selects request instructing section 371. In this case, the component search unit 56 acquires the usage reason which is input into the usage reason inputting section 361, and transmits the usage permission request including the component information of the target component and the usage reason to the component DB management unit 58. When the component search unit 56 receives the substitution refusal instruction, the component search unit 56 may transmit the usage permission request to the component DB management unit 58.

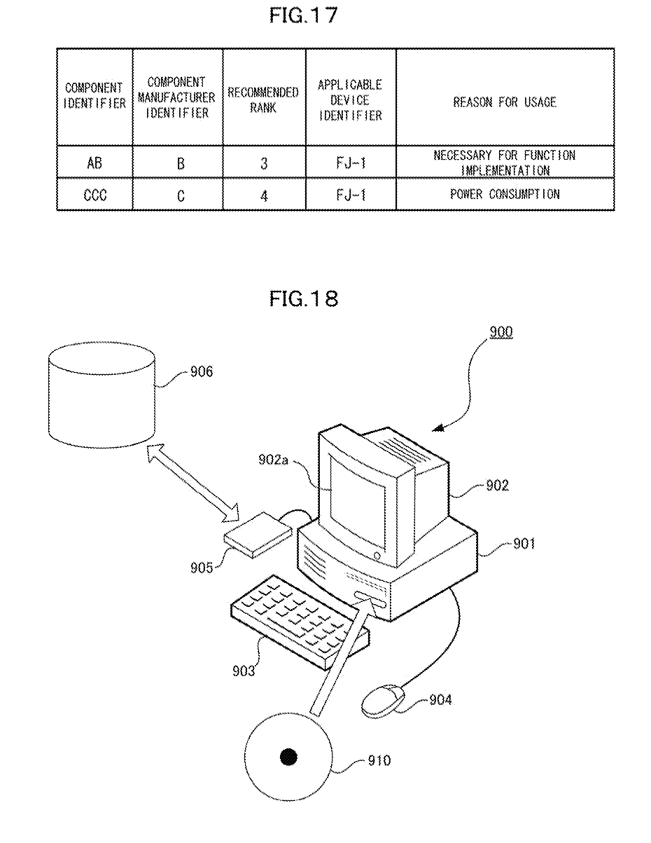

When a trigger of the component DB management processing is reception of the usage permission request, the component DB management unit 58 determines whether or not the acquired evaluation result indicates permission of the component in S216 of the component DB management processing. When the usage reason(s) received from the component search unit 56 is valid, the component DB management unit 58 registers usage permission information indicating usage permission of the target component into the component DB 61 in S217. FIG. 17 is a diagram illustrating the usage permission information. The usage permission information indicates, for each of components, a component identifier, a component manufacturer identifier, a recommended rank, an applicable device identifier and a usage reason. The applicable device identifier is an identifier indicating an electronic device where the component is used. The usage reason is usage reason(s) which is transmitted from the component search unit 56. The component DB management unit 58 transmits a notification of permission in response to the usage permission request, to the component search unit 56 in S218. The component DB management unit 58 transmits a notification of refusal in response to the adoption request, to the component search unit 56 in S219. When the component search unit 56 receives the notification, the component search unit 56 conducts the component selection processing for usage of the component, again.

According to the usage permission request processing, the designer may use the target component when the designer has a valid usage reason for using the target component even if the recommended rank of the target component is lower than the threshold value of recommended rank.

According to the above described electronic device design system 201, even if a recommended rank in the component DB 61 is changed during creation of the design data after selection of components in the design data, the design data may be modified based on the latest recommended ranks by determining a recommended rank of each of the components after the creation of the design data. When a component is selected prior to creation of a circuit diagram and a mounting diagram, when a component is added during the creation of the circuit diagram and the mounting diagram, or when information of a component is stored after the creation of the circuit diagram and the mounting diagram, by acquiring and determining a recommended rank of a component of the design data from the component DB 61, the electronic device design system 201 may deal with changes of the recommended rank in the component DB 61, thereby reflecting the changes of the recommended rank on the design data.

The present invention may be applied to a computer system as described below. FIG. 18 is a view illustrating an example of a computer system to which the present invention is applied. A computer system 900 illustrated in FIG. 18 includes a main body 901 incorporating a CPU, a disk drive, and the like, a display 902 that displays an image according to an instruction from the main body 901, a keyboard 903 for a user to input various pieces of information in the computer system 900, a mouse 904 for a user to specify a given position on a display screen 902a of the display 902, and a communication unit 905 that accesses an external database or the like to download, e.g., a program stored in another computer system. As the communication unit 905, a network communication card, a modem, and the like may be employed.

It is possible to provide as a design program a program that allows a computer to execute the above steps in a computer system constituting the design apparatus for an electronic device. By storing the above program in a storage medium that may be read by the computer system, it is possible to allow the computer system constituting the authentication information management apparatus to execute the program. The program executing the above steps is stored in a portable recording medium such as a disk 910 or downloaded from a recording medium 906 of another computer system by the communication unit 905. A design program allowing the computer system 900 to exert at least a design function is input to the computer system 900 and is compiled therein. The compiled program allows the computer system 900 to operate as a design system having a design function. The program may be stored in a computer-readable storage medium such as a disk 910. The recording medium that may be read by the computer system 900 mentioned here includes: an internal storage device mounted in a computer, such as a ROM (Read Only Memory) or a RAM (Random-Access memory), a portable storage medium such as the disk 910, a flexible disk, a DVD (Digital Versatile Disc), a magneto-optical disk, or an IC card; a database that holds computer program; another computer system and database thereof; and various recording media that may be accessed from a computer system connected thereto through a communication means such as the communication unit 905.

According to another aspect of the present invention, there is provided a design apparatus for an electronic device including: a condition determination unit that determines a characteristic condition which indicates a characteristic of a first component of plural components within the electronic device, based on a component database which includes an identifier, a characteristic and a recommended level of each of components, the recommended level being variable; a selection unit that selects a component which meets the characteristic condition, from the component database; an assignment unit that assigns an identifier of the selected component to an identifier of the first component; a first determination unit that acquires a recommended level of the first component from the component database based on the identifier of the first component, and determines the acquired recommended level; a creation unit that creates design data which indicates the electronic device and includes identifiers respectively corresponding to the plural components; and a second determination unit that acquires, after the creation, a recommended level of the first component from the component database based on the identifier of the first component, and determines the acquired recommended level.

According the technique of the specification, it is possible to determine a component in design data based on the latest evaluation even if component evaluation varies during designing.

Reference numerals 11a and 11b indicate storage devices. Reference numerals 21, 22a, and 22b indicate computers. Reference numeral 50 indicates a design data creation unit. Reference numeral 51 indicates an electrical CAD. Reference numeral 52 indicates a mounting CAD. Reference numeral 54 indicates a list creation unit. Reference numeral 56 indicates a component search unit. Reference numeral 57 indicates an information acquisition unit. Reference numeral 58 indicates a component DB management unit. Reference numerals 59a and 59b indicate operation units. Reference numeral 61 indicates a component DB. Reference numeral 66 indicates a design DB. Reference numerals 101 and 102 indicate computer systems. Reference numeral 111 indicates an internal network. Reference numeral 112 indicates an external network. Reference numeral 201 indicates an electronic device design system. Reference numeral 202 indicates a component supply system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has(have) been described in detail, it should be understood that the various changes, substitutions, and alterations could be made hereto without departing from the spirit and scope of the invention.

What is claimed is:

1. A design apparatus for an electronic device, the apparatus comprising:
a selection unit that selects a first component which meets a characteristic condition, from a component database which includes a characteristic and a recommended level of each of components, the recommended level being variable;
a first determination unit that acquires a recommended level of the first component from the component database, and determines the acquired recommended level;
a creation unit that creates design data of the electronic device including the first component; and
a second determination unit that acquires, after the creation, a recommended level of the first component from the component database, and determines the acquired recommended level after the creation.

2. The design apparatus according to claim 1, wherein each of the first determination unit and the second determination unit determines whether or not the recommended level of the first component is lower than a threshold value of recommended level.

3. The design apparatus according to claim 2, wherein
the component database includes a substitution component identifier indicating a substitution component which is usable instead of a predetermined component in the component database, and
each of the first determination unit and the second determination unit acquires, when the recommended level is lower than the threshold value of recommended level, a substitution component identifier of the first component from the component database, acquires a recommended level of a second component indicated by the substitution component identifier of the first component, and determines whether or not the recommended level of the second component is lower than the threshold value of recommended level.

4. The design apparatus according to claim 3, wherein each of the first determination unit and the second determination unit determines whether or not an instruction for substituting the second component for the first component is received when the recommended level is higher than or equal to the threshold value of recommended level, and substitutes the second component for the first component when it is determined that the instruction is received.

5. The design apparatus according to claim 4, wherein each of the first determination unit and the second determination unit displays information of the second component and receives the instruction, when the recommended level of the second component is higher than or equal to the threshold value of recommended level.

6. The design apparatus according to claim 1, wherein the selection unit displays information including a recommended level of components which meet the characteristic condition, receives a selection instruction for selecting one component from the components which meet the characteristic condition, and selects one component according to the selection instruction.

7. A computer-readable, non-transitory medium having recorded thereon a design program which causes a computer to execute a process comprising:
selecting a first component which meets a characteristic condition, from a component database which includes a characteristic and a recommended level of each of components, the recommended level being variable;
acquiring a recommended level of the first component from the component database, and determining the acquired recommended level;
creating design data of the electronic device including the first component; and
after the creating, acquiring a recommended level of the first component from the component database, and determining the acquired recommended level after the creating.

8. A method of designing an electronic device, the method comprising:
selecting a first component which meets a characteristic condition, from a component database which includes a characteristic and a recommended level of each of components, the recommended level being variable;
acquiring a recommended level of the first component from the component database, and determining the acquired recommended level;
creating design data of the electronic device including the first component; and
after the creating, acquiring a recommended level of the first component from the component database, and determining the acquired recommended level after the creating.

9. The method according to claim 8, further comprising:
modifying the component database in response to an occurrence of a predetermined trigger.

10. A design apparatus for an electronic device, the apparatus comprising
a processor, wherein the processor executes a process comprising:
selecting a first component which meets a characteristic condition, from a component database which includes a characteristic and a recommended level of each of components, the recommended level being variable;
acquiring a recommended level of the first component from the component database, and determining the acquired recommended level;
creating design data of the electronic device including the first component; and
after the creating, acquiring a recommended level of the first component from the component database, and determining the acquired recommended level after the creating.
